(19) United States
(12) Patent Application Publication
(10) Pub. No.: US 2008/0086749 A1
(43) Pub. Date: Apr. 10, 2008

(54) DEVICE, METHOD AND SYSTEM OF WIRELESS COMMUNICATION OF USER INPUT TO A VIDEO SOURCE

(76) Inventors: Netanel Goldberg, Zichron Yaakov (IL); Yoav Nissan-Cohen, Tel Aviv (IL); Noam Geri, Los Altos, CA (US); Meir Feder, Herzliya (IL)

Correspondence Address: EMPK & Shiloh, LLP, 116 JOHN ST,, SUITE 1201, NEW YORK, NY, 10038, US

(21) Appl. No.: 11/860,893

(22) Filed: Sep. 25, 2007

Related U.S. Application Data
(60) Provisional application No. 60/828,569, filed on Oct. 6, 2006.

(51) Int. Cl. H04N 7/26

(52) U.S. Cl. 725/68

(57) ABSTRACT

Some demonstrative embodiments include devices, systems and/or methods of wireless communication of user input to a video source. A wireless video communication system may include, for example, a wireless video transmitter capable of transmitting a wireless video downlink transmission representing video data generated by a video source; and a wireless video receiver capable of receiving the wireless video downlink transmission, capturing a wireless user input signal intended for the video source, and transmitting to the wireless video transmitter a wireless uplink transmission corresponding to the user input signal. Other embodiments are described and claimed

### CROSS-REFERENCE

This application claims priority from and the benefit of U.S. Provisional Patent application 60/828,569, entitled “System and Method for controlling a Home Entertainment Hub Over a Wireless Link”, filed Oct. 6, 2006, the entire disclosure of which is incorporated herein by reference

### FIELD

Some embodiments relate generally to the filed of wireless communication and, more particularly, to wireless communication including video and/or audio information.

### BACKGROUND

Wireless communication has rapidly evolved over the past decades. Even today, when high performance and high bandwidth wireless communication equipment is made available there is demand for even higher performance at a higher data rates, which may be required by more demanding applications,

A media center or a home-entertainment hub may be associated with a plurality of media devices. A typical home-entertainment hub may include a computing device having a processor associated with a suitable storage. The home-entertainment hub may be associated with a plurality of media devices, for example, a Digital-Versatile-Disc (DVD) player, a television (TV) tuner, a MP3 player, a MP4 player, a game console, a photo viewer, a media player, and/or any other suitable media device. The home-entertainment hub may control the various media devices, e.g., to allow a user to play and/or record media, for example, by using suitable software applications. The home-entertainment hub may also include a wired/wireless network connector, e.g., implemented by one or more network cards, to connect to a network, erg., the Internet.

In many houses, the home-entertainment hub may be located at a fixed point. In many cases, it may be desired to place a screen or projector at a location in a distance of at least a few meters from the home-entertainment hub. This trend is becoming more common as flat-screen displays, e.g., plasma or liquid crystal display (LCD) televisions are hung on a wall. Connection of such a display or projector to the home-entertainment hub through cables is generally undesired for aesthetic reasons and/or installation convenience Thus, wireless transmission of the video signals from the home-entertainment hub to the screen is preferred.

### SUMMARY

Some demonstrative embodiments include systems and/or methods of wireless video communication.

Some demonstrative embodiments include a wireless video communication system including a wireless video transmitter capable of transmitting a wireless video downlink transmission representing video data generated by a video source; and a wireless video receiver capable of receiving the wireless video downlink transmission, capturing a wireless user input signal intended for the video sources and transmitting to the wireless video transmitter a wireless uplink transmission corresponding to the user input signal.

In some demonstrative embodiments, the wireless video receiver may include a short range wireless receiver to capture the user input signal; and a radio-frequency module to transmit the uplink transmission and receive the wireless video downlink transmission.

In some demonstrative embodiments, a transmission range of the radio-frequency module is longer than a reception range of the short-range wireless receiver

In some demonstrative embodiments, the short-range receiver may include at least one of a Bluetooth receiver, an infrared receiver, a radio-frequency receiver, and a ZigBee receiver.

In some demonstrative embodiments, the wireless video transmitter is capable of providing the video source with an input corresponding to the user input signal.

In some demonstrative embodiments, the system may include a user input device to generate the user input signal.

In some demonstrative embodiments, a distance between the wireless video receiver and the user input device is shorter than a distance between the wireless video receiver and the wireless video transmitter.

In some demonstrative embodiments, the user input device may include at least one of a keyboard, a mouse, a joystick, a game pad, or a pointing device, a remote control device, a microphone, and a remote universal-serial-bus port.

In some demonstrative embodiments, the wireless video receiver is capable of transmitting the uplink transmission during a vertical blanking period corresponding to the video data.

In some demonstrative embodiments, the system may include a video destination, wherein the wireless video receiver is capable of providing the video destination with an input corresponding to the video data.

Some demonstrative embodiments include a wireless video receiver capable of receiving from a wireless video transmitter a wireless video uplink transmission representing video data generated by a video source, capturing a wireless user input signal intended for the video source, and transmitting to the wireless video transmitter a wireless uplink transmission corresponding to the user input signal.

In some demonstrative embodiments, the wireless video receiver may include a short range wireless receiver to capture the user input signal; and a radio-frequency module to transmit the uplink transmission and receive the wireless video downlink transmission.

In some demonstrative embodiments, a transmission range of the radio-frequency module is longer than a reception range of the short-range wireless receiver.

In some demonstrative embodiments, the short-range receiver may include at least one of a Bluetooth receiver, al infrared receiver, a radio-frequency receiver, and a ZigBee receiver.

In some demonstrative embodiments, the user input signal is out of a reception range of the video source.

In some demonstrative embodiments, the receiver is capable of transmitting the uplink transmission during a vertical blanking period corresponding to the video data.

In some demonstrative embodiments, the user input signal may include a wireless signal generated by a user input device. The user input device may include at least one of a keyboard, a mouse, a joystick, a pointing device, a remote control device, a microphone, and a remote universal-serial-bus port.

Some demonstrative embodiments include a method of wireless video communication including receiving from a wireless video transmitter a wireless video downlink transmission representing video data generated by a video source; capturing a wireless user input signal intended for the video source; and transmitting to the wireless video transmitter a wireless uplink transmission corresponding to the user input signal

In some demonstrative embodiments, capturing the user input signal may include capturing at least one of a Bluetooth signal, an infrared signal, a radio-frequency signal and a ZigBee signal.

In some demonstrative embodiments, the method may include receiving the wireless uplink transmission at the wireless video transmitter; and providing the video source with an input corresponding to the user input signal.

In some demonstrative embodiments, capturing the wireless user input signal may include capturing a wireless signal transmitted by a user input device, wherein a distance between the wireless video receiver and the user input device is shorter than a distance between the wireless video receiver and the wireless video transmitter.

In some demonstrative embodiments, capturing the wireless user input signal may include capturing a signal generated by at least one of a keyboard, a mouse, a joystick, a game pad, or a pointing device, a remote control device, a microphone, and a remote universal-serial-bus port.

In some demonstrative embodiments, transmitting the wireless uplink transmission may include transmitting the wireless uplink transmission during a vertical blanking period corresponding to the video data.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. Moreover, some of the blocks depicted in the drawings may be combined into a single function The figures are listed below.

FIG. 1 is a schematic illustration of a wireless communication system, in accordance with some demonstrative embodiments;

FIG. 2 is a schematic illustration of a wireless video receiver in accordance with some demonstrative embodiments;

FIG. 3 is a schematic illustration of a wireless communication link allocation scheme in accordance with some demonstrative embodiments; and

FIG. 4 is a schematic flow-chart illustration of a method of wireless video communication in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that embodiments of the invention may be practiced without these specific details In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing,” “computing,” “calculating,” “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that some embodiments may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of consumer electronics, for example, as part of any suitable television, video Accessories, Digital-Versatile-Disc (DVD), multimedia projectors, Audio and/or Video (A/V) receivers/transmitters, gaming consoles, video cameras, video recorders, and/or automobile A/V accessories In some demonstrative embodiments the methods, devices and/or systems disclosed herein may be used in the field of Personal Computers (PC), for example, as part of any suitable desktop PC, notebook PC, monitor, and/or PC accessories. In some demonstrative embodiments the methods, devices and/or systems disclosed herein may be used in the field of professional A/V, for example, as part of any suitable camera, video camera, and/or A/V accessories In some demonstrative embodiments the methods, devices and/or systems disclosed herein may be used in the medical field, for example, as part of any suitable endoscopy device and/or system, medical video monitor, and/or medical accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

Although embodiments of the invention are not limited in this respect, one or more of the methods, devices and/or systems disclosed herein may be used to wirelessly transmit video signals, for example, High-Definition-Television (HDTV) signals, between at least one video source and at least one video destination. In other embodiments, the methods, devices and/or systems disclosed herein may be used to transmit, in addition to or instead of the video signals, any other suitable signals, for example, any suitable multimedia signals, e.g., audio signals, between any suitable multimedia source and/or destination.

Although some demonstrative embodiments are described herein with relation to wireless communication including video information, embodiments of the invention are not limited in this respect and some embodiments may be implemented to perform wireless communication of any other suitable information, for example, multimedia information, e.g., audio information, in addition to or instead of the video information. Some embodiments may include, for example, a method, device and/or system of performing wireless communication of A/V information, e.g., including audio and/or video information. Accordingly, one or more of the devices, systems and/or methods described herein with relation to video information may be adapted to perform wireless communication of A/V information.

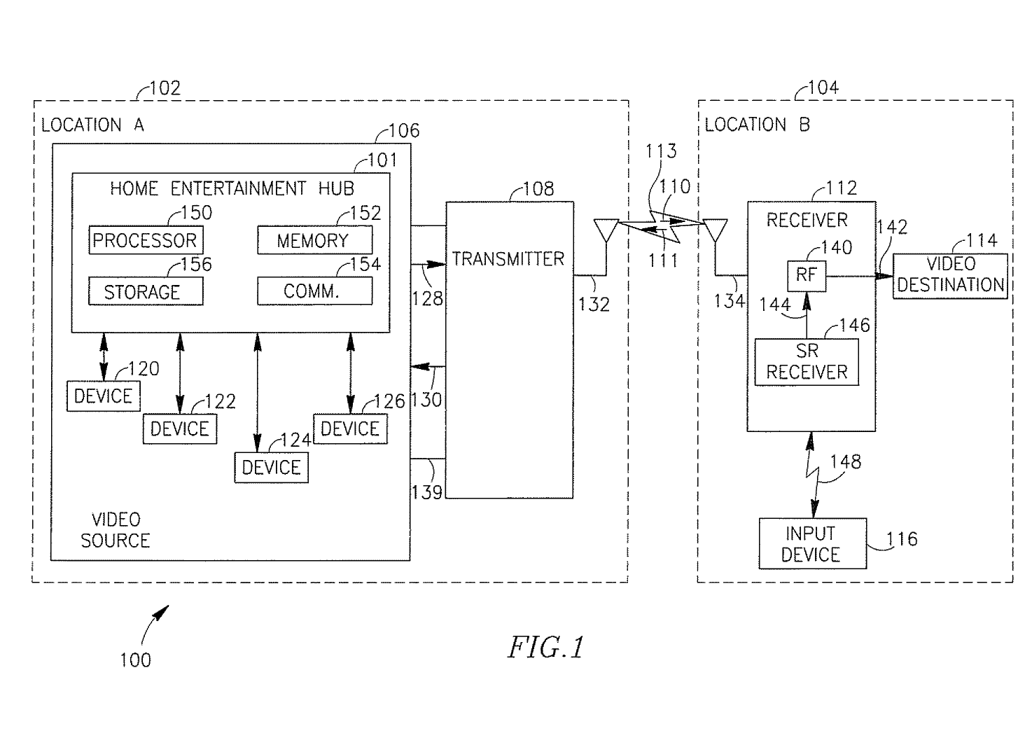

Reference is made to FIG. 1, which schematically illustrates a wireless video communication system 100, in accordance with some demonstrative embodiments.

In some demonstrative embodiments, system 100 may include at least one video source 106 to generate video information, erg., in the form of video signals 128. Video source 106 may generate video signals 128 in any suitable video format. In one example, signals 128 may include HDTV video signals, for example, uncompressed HDTV signals, e.g., in a Digital Video Interface (DVI) format, a High Definition Multimedia Interface (HDMI) format, a Video Graphics Array (VGA), a VGA DB-15 format, an Extended Graphics Array (XGA) format, and their extensions, or any other suitable video format Video source 106 may include any suitable video software and/or hardware, for example, a portable video source, a non-portable video source, a Set-Top-Box (STB), a DVD, a digital-video-recorder, a game console, a PC, a portable computer, a Personal-Digital-Assistant, a Video Cassette Recorder (VCR), a video camera, a cellular phone, a television (TV) tuner, a photo viewer, a media player, a video player, a portable-video-player, a portable DVD player, an MP-4 player, a video dongle, a cellular phone, and the likes

In some demonstrative embodiments, video source 106 may include a home entertainment hub 101 capable of generating video signals 128 based, for example, on inputs received from one or more media devices, e.g. media devices 120, 122, 124, and/or 126. In one example, entertainment hub 101 may generate video signals 128 corresponding to any suitable video application or program, ergo a computer game, a movie, and the like. Media devices 120, 122, 124, and/or 126 may include any suitable module capable of generating media inputs to be provided to home entertainment hub 101. In one example, device 120 may include a playback system, e.g., a stereo playback system; device 122 may include a computer, for example, a portable computer, egg, a laptop computer; device 124 may include an MP3 player; and/or device 126 may include a video playback device, e.g., a DVD player. In other example, devices 120, 122, 124 and/or 124 may include any other suitable media device, e.g., a portable video source, a non-portable video source, a STB, a DVD, a digital-video-recorder, a game console, a PC, a portable computer, a Personal-Digital-Assistant, a VCR, a video camera, a cellular phone, a video player, a portable-video-player, a portable DVD player, an MP-4 player, a video dongle, a cellular phone, a TV tuner, a photo viewer, a media player, an audio source, and the like. For example, video signals 128 may include video data corresponding to a video movie, a computer, game, or any other suitable video program or application.

In some demonstrative embodiments, one or more of devices 120, 122, 124, and/or 126 may be connected to hub 101 directly, e g, via a wired or wireless link; and/or one or more of devices 120, 122, 124, and/or 126 may be connected to hub 101 via any suitable wired or wireless communication network, for example, a Wireless Local Area Network (WLAN), e.g., a WLAN operating in accordance with existing Institute-of-Electrical-and-Electronics-Engineers (ITEE) 802.11, 802.11a, 802.11b, 802.11g, 802.11k, 802.11n, and/or 802.11r standards and/or future versions and/or derivatives and/or Long Term Evolution (LTE) of the above standards.

In some demonstrative embodiments, home entertainment hub 101 may be implemented using any suitable hardware and/or software. In one example, home entertainment hub 101 may include or may be a computing device, a computer, a PC, a server computer, a client/server system, a network of multiple inter-connected devices, or the like.

In some demonstrative embodiments, home entertainment hub 101 may include a processor 150, a memory 152, storage 156, and/or communication unit 154. Processor 104 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller Processor 150 may execute instructions, for example, of a suitable media program, for example, the Microsoft Media Center Edition. Memory 152 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units Storage 156 includes, for example, a hard disk drive, a floppy disk drive, a Compact Disk (CD) drive, a CD-ROM drive, a DVD drive, or other suitable removable or non-removable storage units. Memory 152 and/or storage 156 may store, for example, data processed by home entertainment hub 101 Communication unit 154 may include, for example, a wired or wireless Network Interface Card (NIC), a wired or wireless modem, a wired or wireless receiver and/or transmitter, a wired or wireless transmitter-receiver and/or transceiver, a Radio Frequency (RF) communication unit or transceiver, or other units able to transmit and/or receive signals, blocks, frames, transmission streams, packets, messages and/or data.

In some demonstrative embodiments, system 100 may also include a wireless transmitter 108 to transmit a downlink (DL) wireless transmission 110 including video information corresponding to video signals 128. Transmitter 108 may implement any suitable transmission method and/or configuration to transmit downlink wireless transmission 110. Although embodiments of the invention are not limited in this respect, in some demonstrative embodiments, transmitter 108 may generate downlink wireless transmission 110 according to an Orthogonal-Frequency-Division-Multiplexing (OFDM) modulation scheme, or any other suitable transmission and/or modulation scheme In some demonstrative embodiments, the wireless transmission may include Multiple-Input-Multiple-Output (MIMO) transmission

Although embodiments of the invention are not limited in this respect, according to some demonstrative embodiments downlink wireless transmission 110 may represent a plurality of transformation coefficients corresponding to video signals 128. For example, transmitter 108 may apply a de-correlating transformation, e.g., a DCT and/or a wavelet, to video signals 128, e.g., as described in U.S. patent application Ser. No. 11/551,641, entitled “Apparatus and method for uncompressed, wireless transmission of video”, filed Oct. 20, 2006, and published May 3, 2007, as US Patent Application Publication US 2007-0098063 (“the '641 Application”), the entire disclosure of which is incorporated herein by reference. For example, transmitter 108 may perform the de-correlating transform on a plurality of color components, e.g., in the format Y—Cr—Cb, representing pixels of video signals 128, as described in the '641 Application. In some demonstrative embodiments, downlink wireless transmission 110 may include values of fine constellation symbols, and values of coarse constellation symbols, e.g., as described in the '641 Application.

In some demonstrative embodiments, system 100 may also include a wireless video receiver 112 to receive wireless transmission 110, e.g., as described in detail below Receiver 112 may generate output video signals 142, e.g., corresponding to video signals 108. system 100 may also include a video destination 114, which may include any suitable software and/or hardware to receive, process, store, and/or handle signals 142 in any suitable manner In one example, video destination 114 may include any suitable video display and/or receiver. For example, video destination 114 a display or screen, e.g., a flat screen display, a Liquid Crystal Display (LCD), a plasma display, a back projection television, a television, a projector, a monitor, an audio/video receiver, a video dongle, and the like.

In some demonstrative embodiments, system 100 may also include a wireless input device 116 to generate wireless user input signals 148 intended for video source 106, e.g., based on an input received from a user of system 100. Device 116 may include, for example, a keyboard, a mouse, a joystick, a pointing device, a remote control device, a microphone, a game pad, a remote universal-serial-bus port, and/or any other suitable device capable of generating wireless user input signals 148.

In some demonstrative embodiments, signals 148 may include a control signal to control video source 106, and/or the content of video signals 128 generated by video source 106. For example, signals 148 may include a hub control signal to control hub 101.

In some demonstrative embodiments, device 116 may be compliant with a suitable short-range (SR) wireless communication protocol and/or standard, e.g., Bluetooth, infrared, ZigBee, any suitable RF protocol or standard, and the like. Accordingly, signals 148 may include short-range wireless communication signals, e.g., Bluetooth signals, infrared signals, ZigBee signals, any suitable RF signals, and the like.

In some demonstrative embodiments, video source 106, transmitter 108, receiver 112, video destination 114 an/or input device 116 may be located at one or more suitable locations, e.g., as described blow.

In some demonstrative embodiments, a distance between receiver 112 and input device 116 may be shorter than a distance between input device 116 and home entertainment hub 106, and/or transmitter 108, e.g., as described below.

In some demonstrative embodiments, video source 106 and transmitter 108 be located at a first location 102 (“location A”), while receiver 112, video destination 114, and input device 116 may be located at a second location 104 (“location B”), which may be distant and/or separated by one or more obstacles, e.g., walls, windows, and/or doors, from the first location.

In some demonstrative embodiments, locations 102 and 104 may include, for example, different areas or rooms of a building, premises, plant, house, office, site and the like. In one non-limiting example, location 102 may include a first area of an apartment, e.g., a home-office area, and location 104 may include a second area of the apartment, e.g., a bedroom, or a living room. One or more of the media devices associated with to home entertainment hub 101, erg., devices 120, 122, 124 an/or 126, may be located in proximity to home entertainment hub 101, e.g., at location A; and/or one or, more of the media devices associated with to home entertainment hub 101 may be located at any other suitable location, e.g., at any suitable distance from home entertainment hub 101,

In some demonstrative embodiments, the distance between input device 116 and video source 106, e.g., home entertainment hub 101, may be longer than a transmission range of input device 116 and/or a reception range of video source 106, e.g., of home entertainment hub 101. Accordingly, signal 148 may be out of the reception range of video source 106. As a result, video source 106, e.g., home entertainment hub 101, may not receive wireless signals 148.

In some demonstrative embodiments, receiver 112 may be capable of capturing wireless signals 148, and transmitting to transmitter 108 a wireless uplink (UL) transmission 111 corresponding to signals 148, e.g., as described in detail below.

In some demonstrative embodiments, receiver 112 may include a Short-Range (SR) wireless receiver 146 to capture signals 148, and a RF module 140 to transmit uplink transmission 111 and receive downlink transmission 110, e.g., as described in detail below. For example, receiver 146 may provide RF module 140 with signals 144 corresponding to signals 148, and RF module may transmit uplink transmission 111 based on signals 144, e.g., as described below.

In some demonstrative embodiments, a transmission range of RF module 140 may be longer than a reception range of receiver 146. For example, the transmission range of RF module 140 may be equal to a longer than the distance between receiver 112 and transmitter 108, while the reception range of receiver 146 may correspond, for example, to the transmission range of device 116.

In some demonstrative embodiments, receiver 146 may include a Bluetooth receiver, an infrared receiver, a ZigBee receiver, a suitable RF receiver, and/or any other receiver capable of receiving signals 148.

In some demonstrative embodiments, downlink wireless transmission 110 and uplink wireless transmission 111 may be transmitted by transmitter 108 and receiver 1112, respectively, over a wireless communication link 113, which may include any suitable wireless communication link, e.g., the wireless video communication link described by the '641 application.

In some demonstrative embodiments, transmitter 108 may include at least one antenna 132 to transit transmission 110 and/or to receive transmission 111, and receiver 112 may include at least one antenna 134 to receive transmission 110 and/or to transmit transmission 111. Although embodiments of the invention are not limited in this respect, types of antennae that may be used for antennas 132 and/or 134 may include but are not limited to internal antenna, dipole antenna, omni-directional antenna, a monopole antenna, an end fed antenna, a circularly polarized antenna, a micro-strip antenna, a diversity antenna and the like.

In some demonstrative embodiments, receiver 112 may transmit uplink transmission 111 during a Vertical Blanking (VB) period corresponding to video signals 128, e.g., as described below. In other embodiments, receiver 112 may transmit uplink transmission 111 during any other suitable time period. For example, receiver 112 may transmit at least part of uplink transmission 111 during a downlink period of communication link 113, which may be designated for downlink transmission 110. The transmission of uplink transmission 111 during the downlink period of communication link 113 may be utilized, for example, to achieve a relatively low latency of uplink transmission 111 with respect to signals 148. In another example, receiver 112 may transmit uplink transmission 111 even if, for example, downlink video transmission 110 is not transmitted to and/or received by receiver 112.

In some demonstrative embodiments, transmitter 108 may provide video source 106, e.g., home entertainment hub 101 with an input 130 corresponding to signals 148. In some demonstrative embodiments, video signals 128 may be provided by video source 106 to transmitter 108, and/or signals 130 may be provided by transmitter 108 to video source 106 over a connection 139 in accordance with any suitable format and/or protocol, e.g., DVI, HDMI, VGA, VGA DB-15, XGA, and the like. Connection 139 may include any suitable wired or wireless connection and/or connection interface, for example, an embedded connection, a Universal Serial Bus (USB) interface, a universal asynchronous receiver/transmitter (UART) interface, egg, in accordance with the RS232 UART standard, and the like.

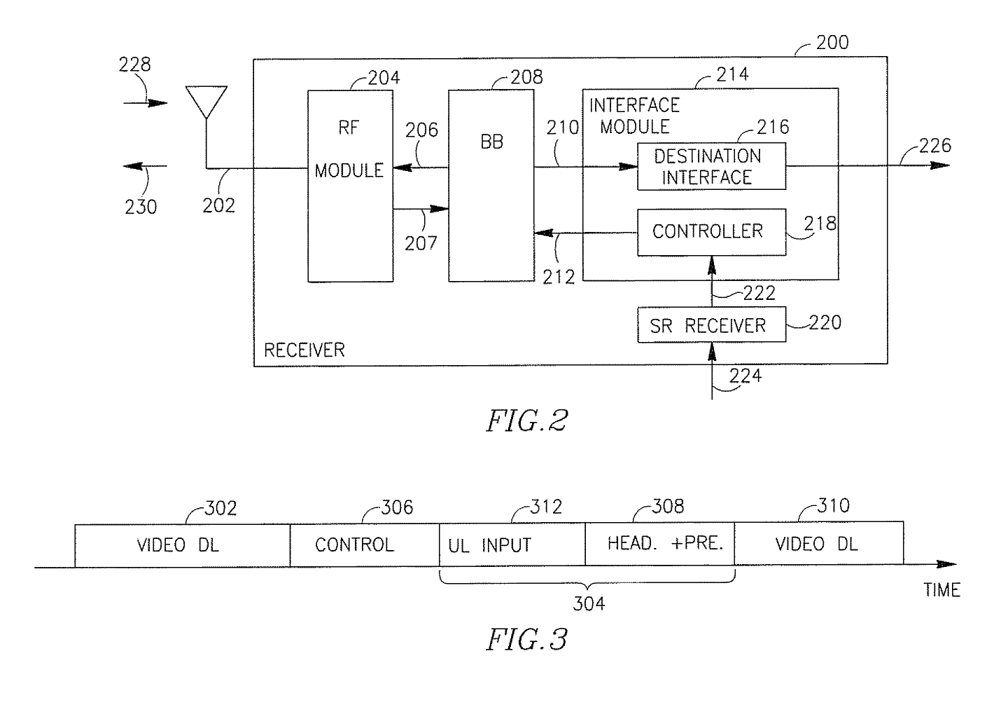

Reference is made to FIG. 2, which schematically illustrates a wireless video receiver 200 in accordance with some demonstrative embodiments. Although embodiments of the invention are not limited in this respect, in some demonstrative embodiments receiver 200 may perform the functionality of wireless video receiver 112 (FIG. 1).

In some demonstrative embodiments, receiver 200 may receive, e.g., from wireless video transmitter 108 (FIG. 1), a wireless video downlink transmission including video data from a video source, e.g., video source 106 (FIG. 1); and provide, edge, to video destination 114 (FIG. 1), output video signals 226 corresponding to the video data, e.g., as described above. Receiver 200 may also capture wireless user input signals 224 intended for the video source, and transmit a wireless uplink transmission 230 corresponding to signals 224, e.g., as described below. Although embodiments of the invention are not limited in this respect, in some demonstrative embodiments downlink transmission 228, uplink transmission 230, and/or user input signals 224 may include downlink transmission 110 (FIG. 1), uplink transmission 111 (FIG. 1), and/or input signals 148 (FIG. 1), respectively.

In some demonstrative embodiments, receiver 200 may include a RF module 204, a base-band (BB) 208, an interface module 214, and a SR receiver 220, as described in detail below.

In some demonstrative embodiments, RF module 204 may receive downlink transmission 228 and/or transmit uplink transmission 230 via at least one antenna 202.

In some demonstrative embodiments, RF module 204 may perform analog-to-digital signal conversion operations to convert analog signals of downlink transmission 228 into digital signals 207 to be provided to BB 208; and/or perform digital-to-analog conversion operations to convert digital signals 206 from BB 208 into analog signals of uplink transmission 230.

In some demonstrative embodiments, BB 208 may generate video and/or audio data signals 210, e.g., corresponding to signals 128 (FIG. 1), for example, by reconstructing video and/or audio information from digital signals 207. For example, BB 208 may demodulate digital signals 207 into a plurality of symbols, which may represent a plurality of transformation coefficients, e.g., corresponding to video signals 128 (FIG. 1). In one example, BB 208 may perform a de-mapping operation and apply a reverse de-correlating transformation, egg, a DCT and/or a wavelet, to the symbols, for example, as described in the '641 Application. Signals 210 may include, for example, a plurality of color components, e.g., in the format Y—Cr—Cb, representing pixels of a video frame, e.g., corresponding to signals 128 (FIG. 1).

In some demonstrative embodiments, interface module 214 may include a video destination interface 216 to generate output signals 226 corresponding to signals 210 in compliance with a video format or protocol implemented by a video destination intended to receive signals 226. For example, video destination interface 216 may generate output signals 226 in accordance with the DVI format, HDMI format, VGA format, VGA DB-15 format, XGA format, and/or any other suitable format.

In some demonstrative embodiments, receiver 200 may also include a SR receiver 220 to capture signals 224 and generate signals 222 corresponding to the captured signals. Although embodiments of the invention are not limited in this respect, in some demonstrative embodiments SR receiver 330 may perform the functionality of SR receiver 146 (FIG. 1). In one example, SR receiver 220 may include a Bluetooth receiver, an infrared receiver, a ZigBee receiver, any suitable RF, and/or any combination thereof.

In some demonstrative embodiments, interface module 214 may include a controller to provide BB 208 with signals 212 corresponding to signals 222. In one example, controller 218 may provide BB 208 with signals 212 during the VB period or any other suitable period, e.g., as described below. BB 208 may generate signals 206 based on signals 212, for example, by performing any suitable modulation and/or conversion operations on signals 212, e.g., applying a serial-to-parallel conversion and/or an inverse-FFT to signals 212. RF module 204 may generate uplink transmission 230 including signals 207.

In some demonstrative embodiments, receiver 200 may transmit uplink transmission 230 during a VB period, e.g., as described below. In other embodiments, receiver 200 may transmit uplink transmission 230 during any other suitable time period, for example, during a downlink period intended for downlink transmission 228.

Reference is made to FIG. 3, which schematically illustrates a wireless communication link allocation scheme 300 in accordance with some demonstrative embodiments. Although embodiments of the invention are not limited in this respect, in some demonstrative embodiments link allocation scheme 300 may be implemented by a wireless communication system, e.g., system 100 (FIG. 1), to communicate uplink and/or downlink wireless transmissions over a wireless link, e.g., link 113 (FIG. 1).

In some demonstrative embodiments, link allocation scheme 300 may include a time period 302 allocated to a downlink wireless transmission of video data corresponding to a video frame, e.g., downlink transmission 110 (FIG. 1) including video data corresponding to a video frame of signals 128 (FIG. 1). In some embodiments, signals 128 (FIG. 1) may include no video data during a predefined time period succeeding each video frame “the VB period”). The VB period may correspond to a time period required for trace back of an electron beam of a Cathode-Ray Tube (CRT).

In some demonstrative embodiments, link allocation scheme 300 may include a VB period 304 corresponding to the VB period of signals 128 (FIG. 1). A portion of the VB period may be allocated to communications exchanging maintenance and/or information. For example, a time period 306 within VB period 304 may be allocated to transmission of one or more uplink control and/or management signals; and/or a time period 308 within VB 304 may be allocated to a downlink transmission of a header and/or preamble corresponding to a succeeding video frame to be transmitted during a succeeding time period 310. A time period 312 of VB period 304 may be allocated to uplink transmission of signals corresponding to the captured wireless user input signals, e.g., signals 148 (FIG. 1).

In some demonstrative embodiments, VB period 304 may have a length of example, 0.67 milliseconds (ms). Periods 306 and 308 may have a length of, for example, at least 350 microseconds. Accordingly, time period 312 may have a length of for example, up to 317 microseconds, which may correspond to a throughput of, for example, up to 100 Kilobit per second.

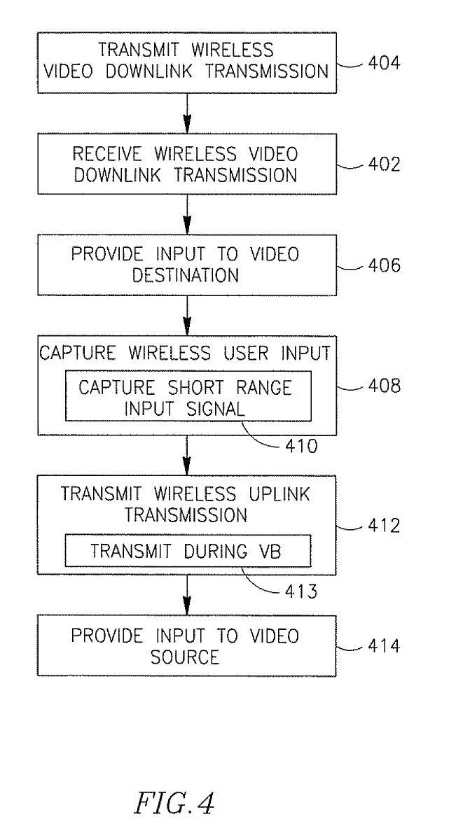

Reference is made to FIG. 4, which schematically illustrates a method of wireless video communication in accordance with some demonstrative embodiments. Although embodiments of the invention are not limited in this respect in some demonstrative embodiments one or more operations of the method of FIG. 4 may be performed by a wireless video communication system, e.g., system 100 (FIG. 1), a wireless video transmitter, e.g., wireless video transmitter 108 (FIG. 1), and/or a wireless video receiver, e.g., wireless video receiver 112 (FIG. 1).

As indicated at block 402, the method may include receiving from a wireless video transmitter a wireless video downlink transmission representing video data generated by a video source. For example, wireless video receiver 112 (FIG. 1) may receive downlink transmission 110 (FIG. 1) representing video data of video signals 128 (FIG. 1) from a video source, e.g., video source 106 (FIG. 1), as described above. In one non-limiting example, the video source may include a home entertainment hub, e.g., hub 101 (FIG. 1), which may execute, for example, a computer game, and signals 128 (FIG. 1) may represent a scene of the computer game.

As indicated at block 404, the method may also include transmitting the wireless video downlink transmission. For example, wireless video transmitter 108 (FIG. 1), may generate downlink transmission 110 (FIG. 1) based on video signals 128 (FIG. 1).

As indicated at block 406, the method may include providing to a video destination an input corresponding to the video data, based on the downlink transmission. For example, wireless video receiver 112 (FIG. 1) may provide video destination 114 (FIG. 1) with signals 142 (FIG. 1), e.g., as described above In one example, the video destination may include a monitor and the wireless video receiver may provide to the monitor video input signals representing the scene of the computer game.

As indicated at block 408, the method may include capturing a wireless user input signal intended for the video source. For example, wireless video receiver 112 (FIG. 1) may capture wireless input signals 148 (FIG. 1) generated by input device 116 (FIG. 1), e.g., as described above. In one example, the wireless user input signal may include infrared signals from a joystick, which may allow a user to control the computer game executed by the home entertainment hub. For example, the user may use the joystick to control the movement of an object or a character in the scene of the computer game, and the input signal may include a signal representing a movement of the joystick.

As indicated at block, 410, capturing the wireless user input signal may include capturing a wireless user input signal from a user input device located at a distance shorter than a distance between the wireless video receiver and the wireless video transmitter. For example, the user and the joystick may be located at a first distance from the receiver and the monitor at a first location, e.g., location 104 (FIG. 1), while the transmitter and the home entertainment hub may be located at a second location, e.g., location 102 (FIG. 1) at second distance, e.g., longer than the first distance, from the user and the joystick.

As indicated at block 412, the method may include transmitting to the wireless video transmitter a wireless uplink transmission corresponding to the user input signals. For example, receiver 112 (FIG. 1) may transmit uplink transmission 111 (FIG. 1), e.g., as described above. In one example, the uplink transmission may include signals representing the movement of the joystick.

As indicated at block 413, transmitting the wireless uplink transmission may include transmitting the wireless uplink transmission during a VB period. For example, receiver 112 (FIG. 1) may transmit uplink transmission 111 (FIG. 1) during the VB period of link 113 (FIG. 1), e.g., as described above.

As indicated at block 414, the method may include providing to the video source input signals corresponding to the user input signals. For example, transmitter 108 (FIG. 1) may provide video source 106 (FIG. 1) with signals 130 (FIG. 1), e.g., as described above. In one example, the wireless video receiver may reconstruct the user input signals representing the movement of the joystick from the received uplink transmission, and provide the reconstructed signals to the home entertainment hub, which may update the scene of the computer game to an updated scene reflecting the movement of the joystick. The home entertainment hub may then provide the wireless video transmitter with updated video signals representing the updated scene; the wireless transmitter may generate a wireless downlink transmission corresponding to the updated video signals; the wireless video receiver may receive the uplink transmission and provide the monitor with video signals corresponding to the updated video scene; and the monitor may display the updated scene.

Some embodiments may be implemented by software, by hardware, or by any combination of software and/or hardware as may be suitable for specific applications or in accordance with specific design requirements. Some embodiments may include units and sub-units, which may be separate of each other or combined together, in whole or in part, and may be implemented using specific, multi-purpose or general processors, or devices as are known in the art. Some embodiments may include buffers, registers, storage units and/or memory units, for temporary or long-term storage of data and/or in order to facilitate the operation of a specific embodiment.

While certain features have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A wireless video communication system comprising:
a wireless video transmitter capable of transmitting a wireless video downlink transmission representing video data generated by a video source; and
a wireless video receiver capable of receiving said wireless video downlink transmission, capturing a wireless user input signal intended for said video source, and transmitting to said wireless video transmitter a wireless uplink transmission corresponding to said user input signal.

2. The wireless video communication system of claim 1, wherein said wireless video receiver comprises:
a short range wireless receiver to capture said user input signal; and
a radio-frequency module to transmit said uplink transmission and receive said wireless video downlink transmission.

3. The wireless video communication system of claim 2, wherein a transmission range of said radio-frequency module is longer than a reception range of said short-range wireless receiver.

4. The wireless video communication system of claim 2, wherein said short-range receiver comprises at least one of a Bluetooth receiver, an infrared receiver, a radio-frequency receiver, and a ZigBee receiver.

5. The wireless video communication system of claim 1, wherein said wireless video transmitter is capable of providing said video source with an input corresponding to said user input signal.

6. The wireless video communication system of claim 1 comprising a user input device to generate said user input signal.

7. The wireless video communication system of claim 6, wherein a distance between said wireless video receiver and said user input device is shorter than a distance between said wireless video receiver and said wireless video transmitter.

8. The wireless video communication system of claim 6, wherein said user input device comprises at least one of a keyboard, a mouse, a joystick, a game pad or a pointing device, a remote control device, a microphone, and a remote universal-serial-bus port.

9. The wireless video communication system of claim 1, wherein said wireless video receiver is capable of transmitting said uplink transmission during a vertical blanking period corresponding to said video data.

10. The wireless video communication system of claim 1 comprising a video destination, wherein said wireless video receiver is capable of providing said video destination with an input corresponding to said video data.

11. A wireless video receiver capable of receiving from a wireless video transmitter a wireless video uplink transmission representing video data generated by a video source, capturing a wireless user input signal intended for said video source, and transmitting to said wireless video transmitter a wireless uplink transmission corresponding to said user input signal.

12. The wireless video receiver of claim 11 comprising:
a short range wireless receiver to capture said user input signal; and
a radio-frequency module to transmit said uplink transmission and receive said wireless video downlink transmission.

13. The wireless video receiver of claim 12, wherein a transmission range of said radio-frequency module is longer than a reception range of said short-range wireless receiver.

14. The wireless video receiver of claim 12, wherein said short-range receiver comprises at least one of a Bluetooth receiver, an infrared receiver, a radio-frequency receiver, and a ZigBee receiver.

15. The wireless video receiver of claim 11, wherein said user input signal is out of a reception range of said video source.

16. The wireless video receiver of claim 11, wherein said receiver is capable of transmitting said uplink transmission during a vertical blanking period corresponding to said video data.

17. The wireless video receiver of claim 11, wherein said user input signal comprises a wireless signal generated by a user input device, and wherein said user input device comprises at least one of a keyboard, a mouse, a joystick, a game pad, a pointing device, a remote control device, a microphone, and a remote universal-serial-bus port.

18. A method of wireless video communication, the method comprising:
receiving from a wireless video transmitter a wireless video downlink transmission representing video data generated by a video source;
capturing a wireless user input signal intended for said video source; and
transmitting to said wireless video transmitter a wireless uplink transmission corresponding to said user input signal.

19. The method of claim 18, wherein capturing said user input signal comprises capturing at least one of a Bluetooth signal, an infrared signal, a radio-frequency signal and a ZigBee signal.

20. The method of claim 18 comprising:
receiving said wireless uplink transmission at said wireless video transmitter; and
providing said video source with an input corresponding to said user input signal.

21. The method of claim 18, wherein capturing said wireless user input signal comprises capturing a wireless signal transmitted by a user input device, wherein a distance between said wireless video receiver and said user input device is shorter than a distance between said wireless video receiver and said wireless video transmitter.

22. The method of claim 18, wherein capturing said wireless user input signal comprises capturing a signal generated by at least one of a keyboard, a mouse, a joystick, a game pad, or a pointing device, a remote control device, a microphone, and a remote universal-serial-bus port.

23. The method of claim 18, wherein transmitting said wireless uplink transmission comprises transmitting said wireless uplink transmission during a vertical blanking period corresponding to said video data.
